(19) United States
(12) Patent Application Publication
(10) Pub. No.: US 2004/0189635 A1
(43) Pub. Date: Sep. 30, 2004

(54) Method and device for providing information being stored in an electronic device to the user of the device

(75) Inventor: Jyrki Hoisko, Oulu (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/749,812

(22) Filed: Dec. 30, 2003

(30) Foreign Application Priority Data
Dec. 31, 2002 (FI) 20022288

(51) Int. Cl. G06T 17/00

(52) U.S. Cl. 345/424; 345/615

(57) ABSTRACT

The invention relates to a method, which provides information to a user in a system comprising a first electronic device, said first electronic device further comprising means for providing at least one control signal for a second electronic device, and a second electronic device, said second electronic device further comprising a storage medium for storing information, providing means for providing said information to the user and a receiver for receiving said control signal. The user places said second electronic device at a distance from said first electronic device for causing said second device to activate said receiver. The device detects said control signal and compares said signal with signal codes being stored in said second electronic device. The device provides information to the user, said information relating to the detected control signal.

The present invention relates to a method and a system for providing information being stored in an electronic device to the user of the device in a display of the device by using especially, but not necessarily RFID technology (Radio Frequency Identification).

### BACKGROUND OF THE INVENTION

Traditionally the user controls the device by pressing keys or other controls located in a limited area on the surface of the device. The system response is presented in graphical display. This type of user interface is not very usable e.g. if the device is very small with small keys in the keyboard and the user has thick gloves in his/her hand, there is no access to keys.

The paper calendars and phone books are superior to all other time and information management methods. However, they cannot be distributed among other users and often the calendar book or phone book is missing. The computer based calendars and phone books can be distributed with other users, but they are in some circumstances overly frustrating to manage and browse.

The calendar and the phone book of a wireless communication device, such as a GSM mobile telephone for example, are always with the user. It can easily be synchronized with the computer calendar (e.g. a laptop or a desktop computer), thus allowing it to be shared with other users. However, it is in some circumstances very uncomfortable to browse, and at the office, many users prefer to use paper or computer calendars and phone books instead. That is because the user has to manually access the mobile phone's calendar and/or phone book using the phone's buttons and menu structure. Browsing in the menu structure may feel difficult and laborious for some users, especially the ones not familiar with mobile phones.

### SUMMARY OF THE INVENTION

The present invention describes a solution for retrieving information being stored in an electronic device to a user of the device. The electronic device comprises a code reader capable of receiving and detecting an identification code. The source or the transmitter of the code can be located e.g. on a surface of an office desk. When the code has been read and detected, the device compares the code to those codes being stored in said device and being linked to a specific operation and/or specific information being stored in said device. If the comparison is successful and the device found an operation and/or information being linked to said code, the device retrieves said information and/or performs said operation and presents the information e.g. visually in the display of the device or in audible format from the speaker of the device.

An advantage of the present invention is that it makes it effortless to retrieve information being stored in an electronic device, e.g. to browse phone's calendar or phone book.

According to a first aspect of the invention a method is provided for providing information to a user in a system that comprises a first electronic device and a second electronic device, characterized in that the user places the first electronic device at a distance from the second electronic device for causing the first device to activate its receiving means where after the first device detects a control signal and compares it with signal codes stored in the first electronic device where after the first device performs at least one command on the basis of the comparison.

According to a second aspect of the invention an electronic device is provided for providing information to a user, characterized in that it comprises receiving means for receiving a control signal, linking means for linking at least one control signal stored in the electronic device to at least one command, which is executed in the electronic device, detecting means for detecting the received control signal and comparing the received control signal with signal codes being linked and stored in the electronic device and performing means for performing at least one command on the basis of said comparison.

According to a third aspect of the invention a computer program product is provided for an electronic device for providing information to a user, characterized in that it comprises receiving means for receiving a control signal, linking means for linking at least one control signal stored in the electronic device to at least one command, which is executed in the electronic device, detecting means for detecting the received control signal and comparing the received control signal with signal codes being linked and stored in the electronic device and performing means for performing at least one command on the basis of said comparison.

In the following, the invention will be described in greater detail with reference to the accompanying drawings, in which

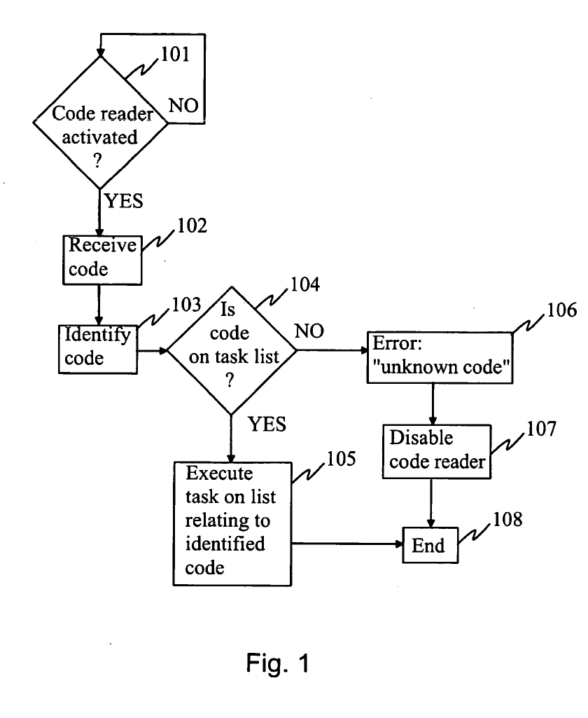

FIG. 1 illustrates as an exemplary flow diagram a method according to an embodiment of the invention,

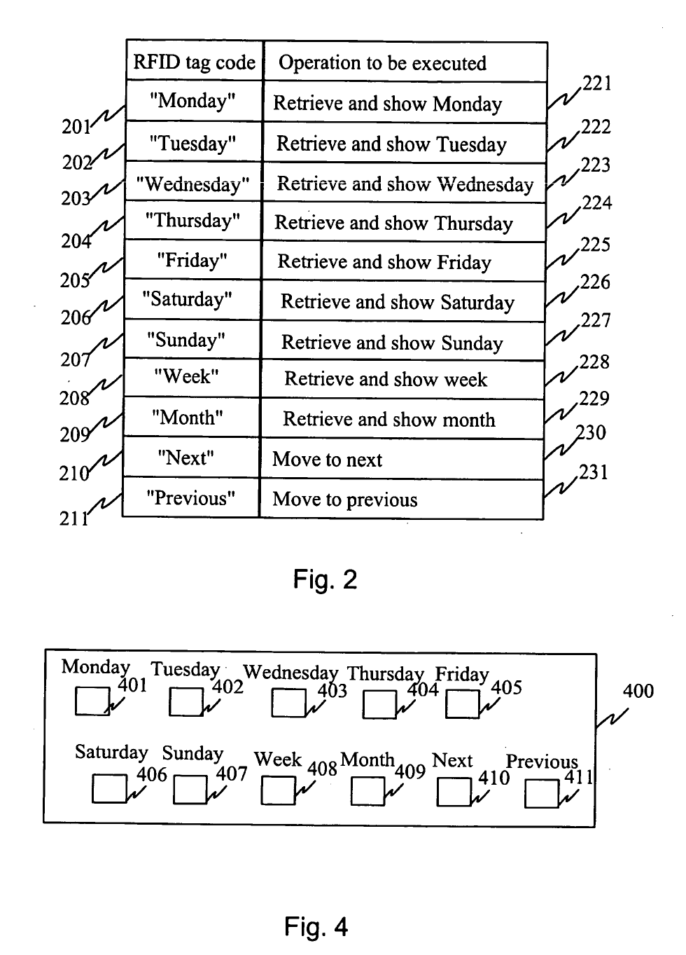

FIG. 2 illustrates an exemplary linkage table according to an embodiment of the invention,

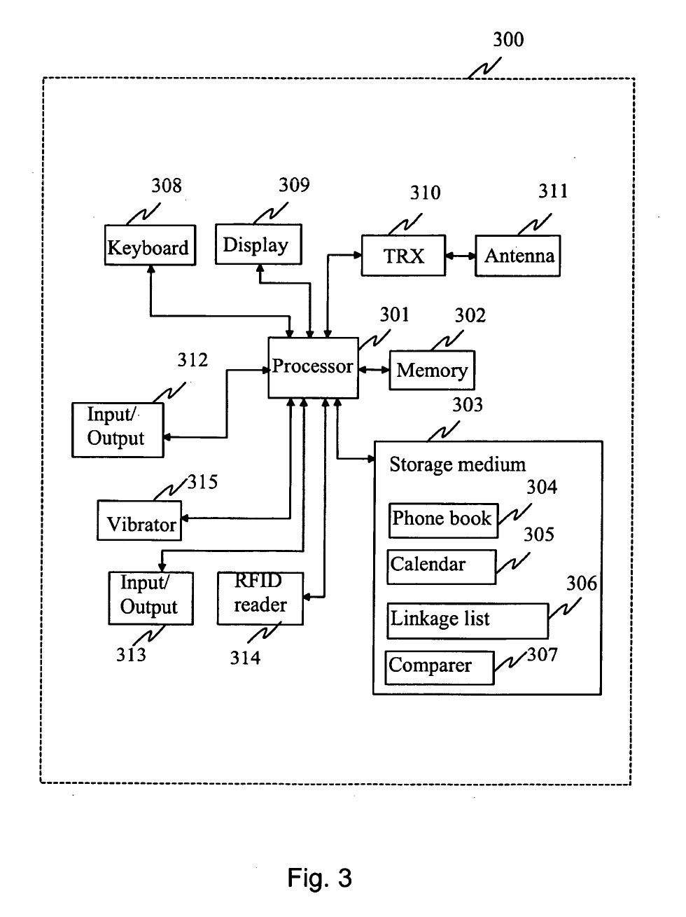

FIG. 3 illustrates an exemplary block diagram of an electronic device according to an embodiment of the invention,

FIG. 4 illustrates an exemplary tag plate according to an embodiment of the invention,

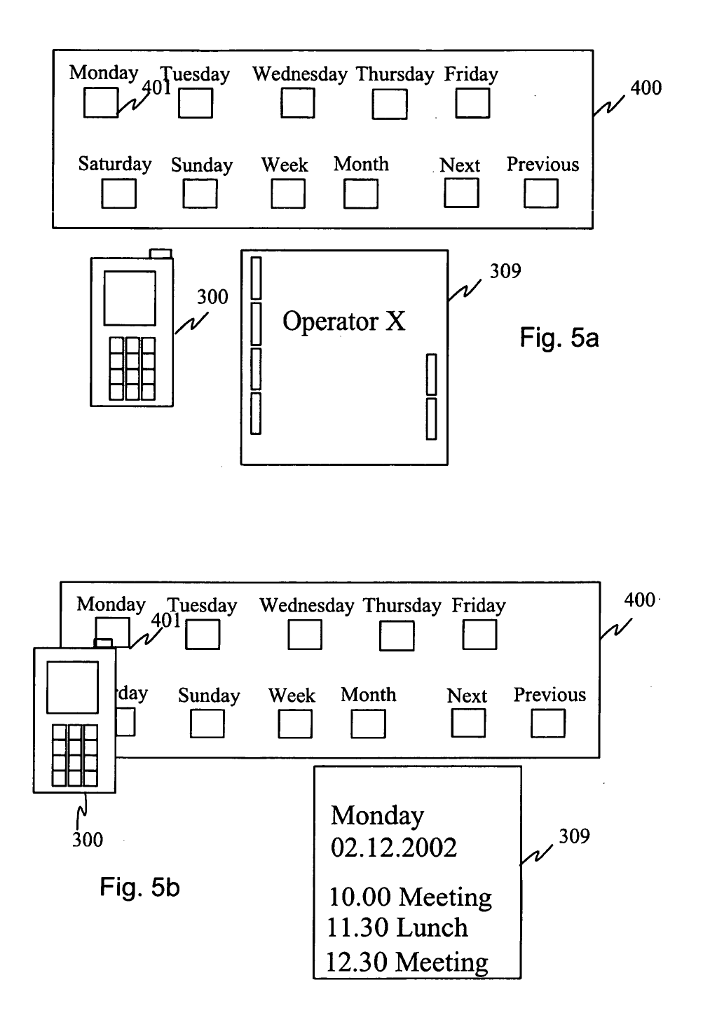

FIG. 5a illustrates an exemplary system according to an embodiment of the invention in an inactive state and

FIG. 5b illustrates a system according to an embodiment of the invention in an active state.

### DETAILED DESCRIPTION OF THE INVENTION

FIG. 1 illustrates an exemplary flow diagram of a method according to an embodiment of the invention. The steps of the method can be implemented for example by a computer program code stored in a memory of an electronic device. The method according to the present invention will be illustrated with reference to FIGS. 1, 2, 5a and 5b.

In FIG. 1 at step 101 it is detected if a code reader of an electronic device is activated. The code reader can be e.g. an RFID reader that can be-activated by the user pressing a button or giving a command. Alternatively the reader can be activated when it is moved advantageously close enough to a RFID tag as illustrated in figures 5a and 5b. If the reader has been activated, the flow proceeds to step 102, wherein the code reader receives a code, advantageously wirelessly if an RFID code is in question. Advantageously an AD converter of the device transforms an analog signal to digital one and software in the device identifies a code from said digital signal. Next, the flow proceeds to step 104, wherein it is checked, if the code is on a task list. One example of the task list is depicted in a linkage table in FIG. 2. This can be done advantageously by comparing the received code to the codes on the list. If the received code is not on the list, the user of the device can be informed by the device that the received code was unknown (step 106). After that, the code reader can be disabled (step 107) and the process ends at step 108.

If the received code is on the list at step 104, software in the device executes a task on the list that relates to said code. Finally the flow proceeds to step 108 and the process ends.

In one advantageous embodiment of the present invention the received RFID Tag code comprises a set of commands in a form of some computer language (e.g. basic, java), of a scripting language (e.g. perl, java script) or of a native binary executable. Because of that the RFID code may compose of set of commands by which a wanted activity is indirectly achieved. For example entering an event can set off several phone user interface actions: e.g. ‘open menu’, ‘scroll to item #2’, ‘open sub-menu’, ‘scroll to item #3’, ‘open item’, ‘enter text “meeting”’.

FIG. 2 illustrates an example of a linkage table according to one advantageous embodiment of the invention. The linkage table can be stored in a memory of an electronic device. The linkage table comprises advantageously RFID tag codes (201-211) and corresponding operations (221-231) to be performed in the electronic device. RFID tag codes have advantageously a unique numerical code e.g. ascii code. An RFID tag code can be e.g. 16-200 bits long binary code that is stored to the memory of the device. The operations 221-231 can be binary codes as well. The electronic device is provided with software that detects the received RFID tag code (binary code) and compares received code to the codes 201-211 on the table. If a match has been found, the software performs the corresponding operation, or informs another software to perform the operation in question.

FIG. 3 illustrates an exemplary block diagram of an electronic device 300 according to an advantageous embodiment of the invention. The device 300 comprises a processor 301 and a memory 302 for processing the operations being performed in the device 300. The device also advantageously comprises a storage medium 303 for storing applications and information, e.g. phonebook 304, calendar 305, a linkage list 306 and a comparer application 307. The linkage list 306 comprises advantageously identification codes and operations linked to the codes as disclosed in the description of the FIG. 2. The device 300 further comprises a keyboard 308 and a display 309 for inputting and outputting information from and to the user of the device 300. The device 300 is connectable to a communication network and/or to another devices by means of a transceiver 310, an antenna 311 and an Input/Output means 313 e.g. an infrared connection or cable connection, such as an USB-, Blue tooth, Serial- or Fire Wire connection, for example. The device 300 advantageously further comprises a RFID reader 314 for detecting RFID code from RFID tag being located for example on a surface of a calendar 400 as illustrated in FIG. 4. The code reader 314 is not restricted to a RFID reader. Depending on the tag system to be used, the code reader can be advantageously a barcode reader, if a barcode is presented on the surface of the calendar 400. It can also be an infrared (IR) sensor, if an IR transmitter is located on the surface of the calendar 400.

The RFID reader 314 receives a code sent by an RFID tag for example. The activation of the reader 314 can be done as illustrated in the description of the FIG. 1. The code received by the reader 314 is then AD converted to a digital form and compared with the codes being stored e.g. in the linkage list 306. A comparer application 307 will compare the received code with the codes on the linkage list 306 and if the comparison is successful the processor of the device then executes one command that is linked to the received code.

The device 300 is advantageously a wireless communication device, such as a mobile telephone operating in a communication system such as GSM system for example.

FIG. 4 illustrates an example of a code plate according to an embodiment of the invention. The code plate 400 comprises RFID tags 401-407 one tag for each day of a week. The code plate 400 further comprises an RFID tag 408 for week display and an RFID tag 409 for month display, i.e. the device displays one whole week or one whole month on the display. Also there are RFID tags advantageously for the commands “next” (410) and “previous” (411). When the reader of the device receives a code transmitted by a tag on the plate 400, the device performs the action being linked to that particular code.

The tags in the code plate 400 have each an ID code. The length of the code is depicted by the RFID structure. It can be anything advantageously between 16 and 4 kbytes For example known from the art there are RFID chips manufactured by Hitachi that can be read as far as from 30 cm apart and they comprise 200 bits of information. RFID tags can be either only readable or also writable.

An electronic device, advantageously a cellular phone, comprises an RFID reader device that is capable of reading the tag without galvanic connection with the tag, for example 5 cm apart. The reader thus provides via air energy, which is needed in operations of the tag, similarly as in electrical transformers. The user might need to initiate the reading operation by pushing a button in the device. Alternatively the code plate 400 advantageously comprises magnets that induce an electric voltage to a coil used in the phone, while the user is moving the phone towards the plate. This voltage advantageously triggers the RFID reading sequence, which consumes power and thus cannot be always on.

Another technique known in the prior art is as follows. The RFID reader has all the time a little current in its reading coil for generating a small magnetic field. When the RFID tag is under the reader of an electronic device, the RFID tag induces some power, which can be detected by the RFID reader. This triggers an actual reading sequence in the electronic device. During the reading sequence power levels are raised both in the RFID tag and in the RFID reader of the electronic device in a necessary level.

A length of 200 bits for a tag is enough for most purposes. There are pre-defined ID numbers, which the phone understands as a calendar control commands e.g. “this weeks Monday”, “Tuesday”, etc, “day view”, “week view”, “next day”“previous month”, “make an appointment on selected day”, etc. These tags are for example embedded in the code plate 400 that resembles a paper calendar. The code plate could also be an attachable add-on for any paper calendar (table or wall calendar). In one advantageous embodiment RFID tags are embedded in the covers of a paper calendar. The plate can also be a stand-on for any calendar. When the code plate is used as an attachable unit for paper calendars, it is easy for the user to synchronize paper and the electrical calendars. The phone advantageously requests the latest calendar information via Blue tooth from a personal computer (PC) as well.

While the electronic device, e.g. previously mentioned cellular phone, is brought near a tag, the tag code is read and interpreted as described above. If it is related to calendar commands, the calendar application is launched and a corresponding calendar view is shown in the display 309 of the cellular phone 300 as illustrated in the figure 5b. Alternatively or in addition to that the user might need to initiate the RFID reading sequence by pressing a button of the electronic device.

The tags in the code plate 400 can be covered with absorbing material and placed so that they do not interfere each other, which is a matter of mechanical design. The RFID tags 401 to 411 can send the code to their surroundings either continuously or only when needed. Also there can be a power supply integrated or connected to the code plate 400 to provide needed power to the tags.

FIG. 5a illustrates an exemplary system according to an embodiment of the invention in an inactive state. The reader 314 of the device 300 is located farther than a predetermined distance from the RFID tag 401 of the code plate 400. On the display 309 of the device 300 can be presented e.g. an operator name and/or logo. Let us now assume that it is Monday morning and the user of the device 300 has just arrived to his/her office. The user of the device 300 has decided to read calendar information of the present week.

FIG. 5b illustrates as an example the system of the FIG. 5a in an active state. In order to read the information on the display 309 of the device 300, the user moves the device 300 nearer to the RFID tag 401. When the reader 314 is closer to the RFID tag 401 than a predetermined distance, the reader is activated and it receives the code, which the RFID tag 401 is sending. By aid of software stored in the device 300 a processor of the device 300, which is not shown in the FIG. 5b, performs operations in order to receive and detect the code and to compare the received code with codes being stored in the device 300. Said stored codes are linked to information and operations of calendar application, which is stored in the device 300 similarly as illustrated in FIG. 2. If the code being received from the tag 401 is linked to an information and/or operation at the device 300, the processor e.g. performs said operation “Retrieve and show Monday” as illustrated in FIG. 2. After that on the display 309 of the device 300 an agenda of the specific day is presented.

The above disclosure illustrates the implementation of the invention and its embodiments by means of some advantageous examples. A person skilled in the art will find it apparent that the invention is not restricted to the details of the above-described embodiments and that there are also other ways of implementing the invention without deviating from the characteristics of the invention. For example the RFID reader can also be as a separate accessory for a mobile phone. Thus the RFID code that is read by the RFID reader accessory is sent wirelessly for example over Bluetooth, Infrared, or some other short-range connectivity means to the phone. The above embodiments should be considered as illustrative and not restrictive. Hence the possibilities of implementing and using the invention are only restricted by the accompanying claims and therefore the different alternative implementations of the invention, including equivalent implementations, defined in the claims also belong to the scope of the invention.

1. A method for providing information to a user in a system that comprises a first electronic device (300) and a second electronic device (400), said second electronic device (400) comprising means for providing at least one control signal to said first electronic device (300), said first electronic device (300) comprising receiving means (314) for receiving said control signal, a storage medium (303) for storing information, providing means (309) for providing said information to the user and, characterized in that the method comprises of steps where
the user places the first electronic device (300) at a distance from the second electronic device (400) for causing the first device to activate the receiving means (101),
the first device detects the control signal and compares it with signal codes stored in the first electronic device (102, 103, 104) and
the first device performs at least one command on the basis of the comparison (105).

2. A method according to claim 1, characterized in that the first device (300) further comprises a calendar application and that the first electronic device performs at least one command causing the first electronic device to retrieve and provide information to the user from the calendar application.

3. A method according to claim 1, characterized in that the first device (300) further comprises a phonebook application and that the first electronic device performs at least one command causing the first electronic device to retrieve and provide information to the user from the phone book.

4. A method according to claim 1, characterized in that the control signal is one of the following: an ascii code, a command of a computer language, a command of a scripting language or a native binary executable command.

5. An electronic device (300) for providing information to a user, the device comprising a storage medium (303) for storing information, providing means (309) for providing said information to the user, characterized in that the electronic device (300) further comprises
receiving means (314) for receiving a control signal,
linking means (306) for linking at least one control signal stored in the electronic device to at least one command, which is executed in the electronic device,
detecting means for detecting (307) the received control signal and comparing the received control signal with signal codes being linked and stored in the electronic device and
performing means (301, 302) for performing at least one command on the basis of said comparison.

6. An electronic device according to claim 5, characterized in that the receiving means (314) are arranged to receive the control signal wirelessly as a radio frequency signal.

7. An electronic device according to claim 5, characterized in that the electronic device further comprises a calendar application and that the performing means (301, 302) are arranged to perform at least one command causing the electronic device to retrieve and provide information to the user from the calendar application.

8. An electronic device according to claim 5, characterized in that the electronic device further comprises a phonebook application and that the performing means (301, 302) are arranged to perform at least one command causing the device to retrieve and provide information to the user from the phone book.

9. An electronic device according to claim 5, characterized in that the performing means (301, 302) are arranged to provide the information as at least one of the following: audible information or visual information.

10. An electronic device according to claim 5, characterized in that the electronic device is a wireless communication device operating in a wireless communication network.

11. A computer program product for an electronic device (300) for providing information to a user, the device comprising a storage medium (303) for storing information, providing means for providing said information to the user, and receiving means (314) for receiving a control signal, characterized in that the computer program product comprises
computer program code for causing the electronic device (300) to detect the control signal and compare the control signal with signal codes linked and stored in said electronic device and,
computer program code for causing the electronic device (300) to perform at least one command on the basis of the comparison.
